(19) United States
(12) Patent Application Publication
(10) Pub. No.: US 2007/0271992 A1
(43) Pub. Date: Nov. 29, 2007

(54) Electrically Operated Pressing Tool

(76) Inventor: Rene Amherd, Wollerau (CH)

Correspondence Address: PAULEY PETERSEN & ERICKSON, 2800 WEST HIGGINS ROAD, SUITE 365, HOFFMAN ESTATES, IL, 60195, US

(21) Appl. No.: 10/581,390

(22) PCT Filed: Oct. 12, 2004
(86) PCT No.: PCT/CH04/00620

§ 371 Date: Apr. 12, 2007

(30) Foreign Application Priority Data
Dec. 4, 2003 (CH) 2068/03

(51) Int. Cl. B25B 27/10; B21J 9/18

(52) U.S. Cl. 72/453.19; 72/453.16

(57) ABSTRACT

For handling reasons, this invention makes it possible to construct electrically operated pressing tools as compact as possible. The pressing tool includes a hydraulic pump that acts upon a piston-cylinder unit by which locking pliers can be actuated by a roll holder with rolls. During actuation, hydraulic oil is conveyed out of an elastic hydraulic oil reservoir and into the cylinder chamber and, from there, flows back again after a pressure build-up. To save space, according to this invention the hydraulic oil reservoir is formed as a sleeve that sealingly acts as a cylinder housing of the piston-cylinder unit. An actuating valve in the piston-cylinder unit can be actuated while passing through the sleeve.

### BACKGROUND OF THE INVENTION

1. Field of the Invention

This invention relates to an electrically operated pressing tool with a hydraulic pump which acts on a hydraulic piston-cylinder unit actively connected to a roller holder with rollers that roll on the clamping jaws of a clamping pincer and thus move these relative to one another. The pressing tool apparatus has a hydraulic oil accommodation container, as well as an actuation valve for opening a passage of a forward conduit into a return conduit between the hydraulic oil receiver container and the cylinder space of the piston cylinder unit.

2. Discussion of Related Art

Electrically operated pressing tools have been available on the market for many years. Portable, hydraulically impinged pressing tool apparatus of the initially mentioned type are used for pressing coupling elements, such as press sleeves, press fittings, pipe muffs, tube sections inserted into one another, and likewise. The pressing tools comprise a clamping pincer with clamping jaws, which form a pressing space for accommodating the coupling element to be pressed. The pressing force required for the pressing is generally provided by a hydraulic drive. All apparatus available today are relatively large and accordingly heavy. Reductions of the construction size have not been successful because of the demands which compellingly result from the construction shape, up to now. Changes in the size of the pressing pincers would limit their field of application and thus according to the knowledge present to this day, the pressing pincer may not be reduced in size. The corresponding roller holder must be adapted in size to the pressing pincer and this also applies to the fork-like receiver in which the pressing pincer is held and which is usually manufactured with the subsequent cylinder housing as one piece. The size of the cylinder housing is practically dependent on the forces to be mustered and these forces depend on the size of the clamping pincer. A conduit block arranged after the cylinder housing but manufactured with this as one piece creates the connections between the cylinder space and a subsequent hydraulic pump. Finally an electrometric drive, or a battery, for feeding the electric motor, yet follows the hydraulic pump.

The required hydraulic oil is suctioned out of a hydraulic oil container and is pumped into the cylinder. Thus, the piston is displaced in the actuation direction and the clamping pincer is closed. Once such a clamping procedure has been completed, then with many apparatus the hydraulic oil is pumped back into the hydraulic container and with some devices of this type, by way of a suitable actuation valve, a direct return from the forward conduit to a return conduit or suction conduit is effected. The mentioned functions necessitate a construction as described above. Accordingly, a miniaturization is practically not possible without a reduction in performance. A reduction in the size of the pressing pincer apparatus as a result may only be achieved by way of innovative measures.

### SUMMARY OF THE INVENTION

Thus, it is one object of this invention to provide a pressing pincer apparatus of the initially mentioned type so that the overall construction of the apparatus may be reduced. A pressing pincer apparatus of the initially mentioned type, with the features of this invention, achieves this object. Thus, the volume of the apparatus is reduced by the space of a separately incorporated hydraulic oil supply container and the total apparatus and its housing is accordingly reduced.

The solution according to this invention may also be achieved with a pressing pincer apparatus having a manually actuatable actuation valve for returning the hydraulic oil from the forward conduit directly into the oil supply space via the return conduit. For this purpose, according to this invention, the actuation valve is attached so that in the piston-cylinder unit, it is completely covered by the elastic sleeve and the actuation of the valve is effected by pressure on the elastic sleeve. With this arrangement, the piston-cylinder unit may be constructed much shorter than previously possible.

Further advantageous embodiments of the subject-matter of this invention are discussed in this specification and in the claims, and their significance and manner of operation are explained in view of the accompanying drawings.

### BRIEF DESCRIPTION OF THE DRAWINGS

One embodiment of this invention is shown and described in more detail in the drawings, wherein:

FIG. 1 shows a perspective view of one embodiment of a pressing tool apparatus, according to this invention;

FIG. 2 shows a section taken through a function part of a known pressing tool apparatus;

FIG. 3 shows a sectional view of this function part in one design according to this invention;

FIG. 4 shows a partial sectional view of the same function part according to FIG. 3, but rotated by 90°;

FIG. 5 shows a longitudinal sectional view of only the piston cylinder part, omitting an elastic sleeve according to this invention; and

FIG. 6 shows a longitudinal partial sectional view of the same part as shown in FIG. 5, but rotated by 90°.

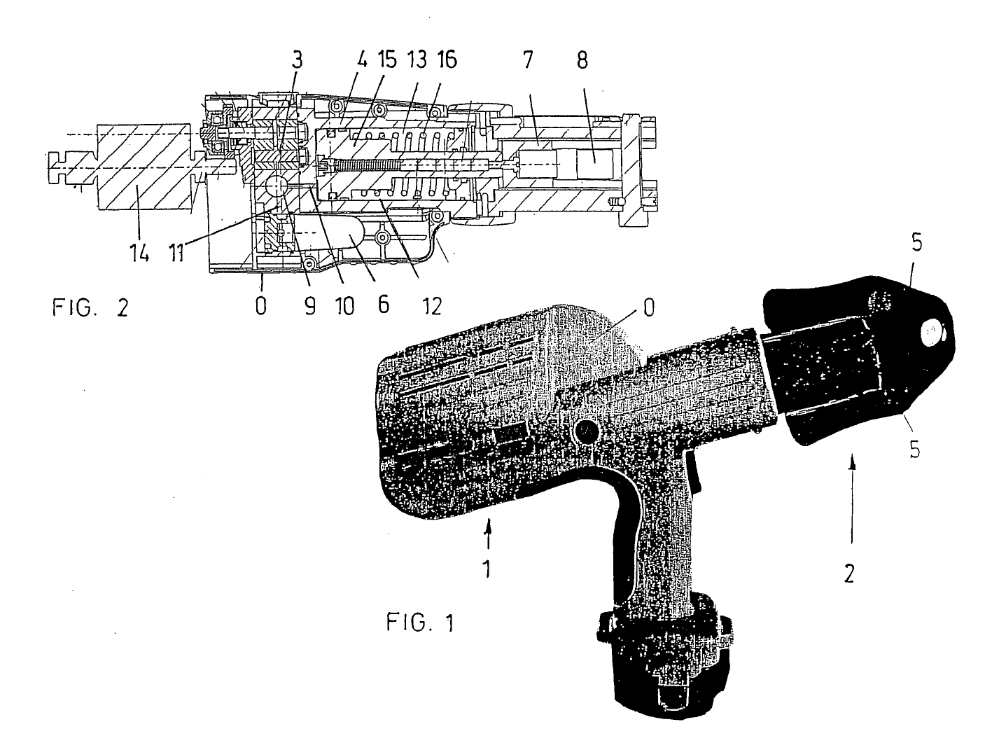

### DETAILED DESCRIPTION OF THE INVENTION

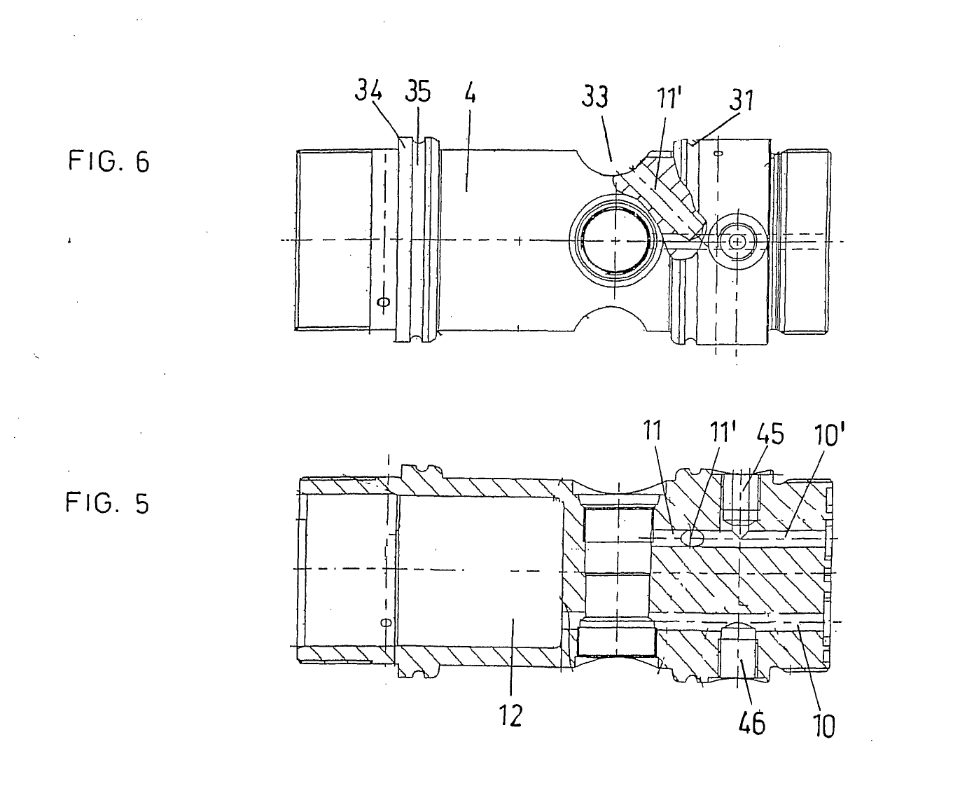

One embodiment of the press tool apparatus according to this invention is shown in a form as will come onto the market. The actual function part is packaged in a plastic housing. The clamping pincer 2 which has two clamping jaws 5 held in a fork-like receiver via a secured bolt. The rollers 8 are located in the fork-like receiver and are rotatably mounted in a roller holder 7. The rollers 8 are pushed to the front by a piston cylinder unit, wherein the clamping jaws 5 close. In FIG. 5, the clamping jaws 5 are shown in the closed condition.

For an improved understanding, the function part of a conventional pressing tool apparatus is known from European Patent EP-A-1,157,786, and is shown with reference to FIG. 2 and is briefly explained in order to clarify this invention. The function unit comprises a hydraulic pump 3 which is shown as a gearwheel pump. The hydraulic pump 3 suctions hydraulic oil via a suction conduit 11 out of an elastic hydraulic oil accommodation container 6 and pumps the hydraulic oil via the forward conduit 10 into the cylinder space 12 and at the same time pushes the piston 15 to the front. At the same time, a roller holder 7 with rollers 8 mounted therein is pushed forwards via the piston rod, wherein the rollers 8 bearing on the clamping jaws 5 push these outwards and thus close the clamping pincer 2.

After completion of the pressing procedure, the drive motor 14 is still and the hydraulic pump 3 is no longer in operation. By actuating the actuation valve 9, a connection is created between the forward conduit 10 and the return conduit 11 and the hydraulic oil flows into the cylinder space 12 back into the elastic hydraulic oil accommodation container 6. During this phase the restoring spring 16 pushes the piston 15 back into the initial position and the hydraulic oil flows through the described path via the actuation valve 9 into the elastic hydraulic oil accommodation container 6. With this design, the hydraulic oil accommodation container 6 lies below the piston cylinder unit 4 within a housing 0 of the pressing tool apparatus 1. This arrangement enlarges the overall housing 0 and thus the entire pressing tool apparatus 1. The solution according to this invention provides for a much more space-saving variation, which is simplified with regard to manufacturing technology.

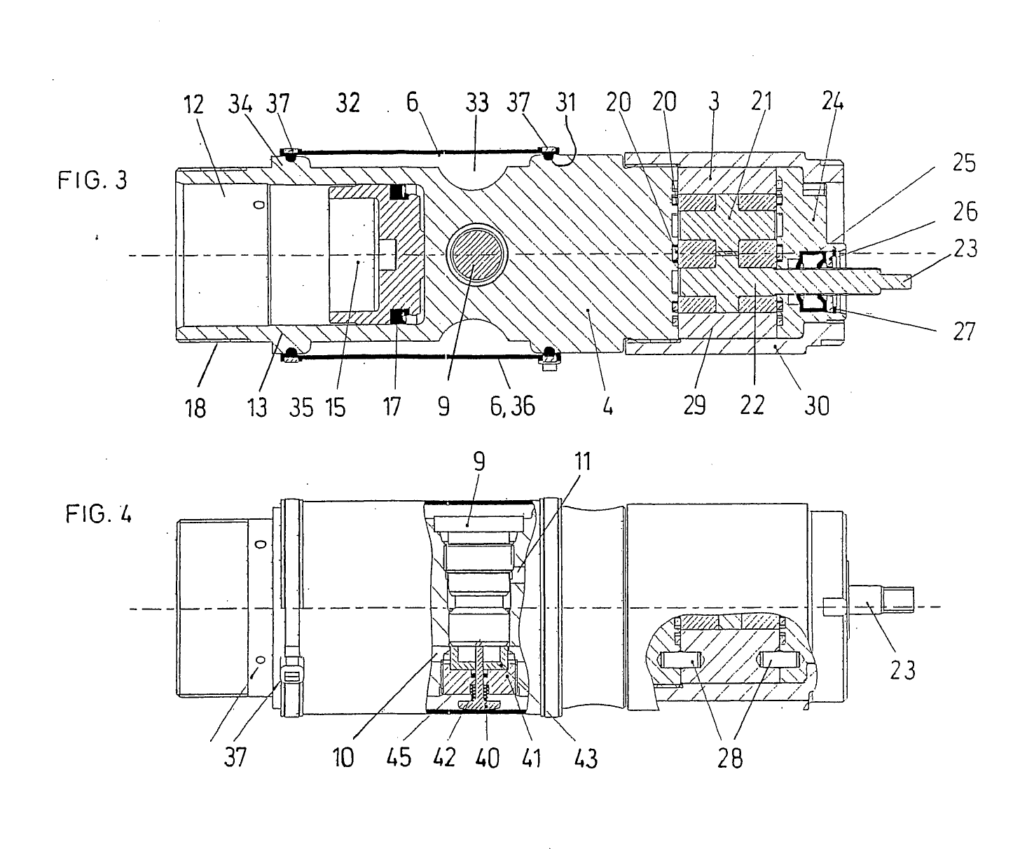

Again the function unit as is shown in FIG. 2, is shown in FIG. 3, but with the design according to this invention. In the embodiment shown here, the piston rod is omitted just as the parts which are fastened thereto, specifically the roller holder 7 and the rollers 8 therein mounted. The piston 15 is shown with its piston seal 17, and on the cylinder housing 13 at the end side a thread 18 is present for fastening the cylinder head. The cylinder housing 13 is connected to the piston-cylinder unit 4 as one piece. That end of the piston cylinder unit 4 lying opposite the cylinder space 12 has bearing receivers 20 in which shape parts of the hydraulic pump are mounted in a fastened manner. Bearings of the gearwheels 21 and 22 are likewise formed into this end wall of the piston cylinder unit 4. A shaft 23 is integrally formed on the gearwheel 22 of the gearwheel pump 3 and is connected to the drive motor 14, which is not represented. The shape parts of the hydraulic pump 3 as well as the gearwheels 21, 22 and the drive shaft 23 are mounted in a bearing head 24. The drive shaft 23 is sealed to the outside with a seal 25 and held in this position by a pressure ring 26 and a circlip ring 27. The pump housing 29 by a bolt 28 is secured with respect to the piston cylinder unit 4 as well as to the bearing head 24, as is evident in the region of the part section in FIG. 4.

A union nut 30 is pushed over the bearing head 24 and the hydraulic pump 3 and is screwed on the piston cylinder unit 4.

The piston cylinder unit 4 has a maximum diameter directly connecting to the union nut 30 and roughly corresponds to its diameter. In this region, the piston cylinder unit 4 comprises a first retaining groove 31. Subsequently, the piston cylinder unit 4 is reduced in diameter and thus forms an annular chamber 32. The volume of the annular chamber 32 is also enlarged by an annular groove 33. In the region of or near the cylinder housing 13, connecting to the annular chamber 32, an annular bead 34 is integrally formed on the cylinder housing, wherein the diameter of the annular bead 34 again corresponds to the diameter of the piston cylinder unit in the region of the first retaining groove. A second retaining groove 35 is formed into the annular bead 34. A sleeve 36, preferably of rubber-elastic material, covers the entire region between the first and the second retaining groove 31, 35. The elastic sleeve 36 thus forms the hydraulic oil accommodation container 6. The elastic sleeve 36 is held on the piston cylinder unit with a positive as well as a friction fit. For this, the elastic sleeve 36 comprises suitable beads which lie in the first and second retaining groove 31, 35. Clamping clips 37 arranged above and which may be cable binders ensure the non-positive connection. The piston-cylinder unit 4 is traversed by the actuation valve 9 within the region which is covered by the elastic sleeve 36 and preferably in the region in which the annular groove 33 is arranged for the increase of the volume. This actuation valve 9 lies perpendicularly with respect to the section plane in FIG. 3.

The same actuation valve as in FIG. 3 is shown in FIG. 4, but rotated by 90°, and is only partly sectioned. The first part section region serves for the fastening of the hydraulic pump and the second part section region is attached where the actuation valve 9 runs. Again, European Patent EP-A-1,157,786 is referred to with regard to the manner of functioning and the construction of the actuation valve 9. The actuation valve 9 creates a connection between the forward conduit 10 and the return conduit 11 or blocks this connection, depending on the switched condition. The manual actuation of the valve 9 is affected via an actuation plunger 40 which passes through a bearing journal 41. A spring 42 is admitted in the bearing journal 41 and acts on the actuation plunger 40 and presses the actuation plunger to the outside onto the inner wall of the elastic sleeve 36. An actuation button 44 is in the housing 0 of the pressing tool apparatus 1 and may be brought into active connection with the actuation plunger 40 in an axially flush manner. Thus the problematic sealed leading-through through the hydraulic oil accommodation container 6 is avoided.

Simultaneously, a filter 43 is applied between the actuation valve 9 and the bearing journal 41. The filter 43 may for example be realized of a sintered metal or plastic granulate with a suitably selected pore size. The oil filter 43 is passed through by the actuation plunger 49 and is accordingly sealed to the outside by a sealing ring 45.

The two FIGS. 5 and 6 finally show the piston cylinder unit 4 represented on its own, wherein the actuation valve is not shown. Here, the bore which extends in a straight line from the pump region up to into the cylinder space 12, and the bore represents the forward conduit 10 and transversely passes through the receiver bore for the actuation valve. A second bore runs parallel to this bore which forms the forward conduit 10 and the second bore extends from the pump attachment side up to into the transverse bore in which the actuation valve 9 comes to lie and the bore is subdivided into two sections by a second bore which opens into the bore. The actual return conduit 11 is from the valve bore up to the opening of the second bore. From here then runs a part section 11′ roughly at an angle of 45°, which is simultaneously the suction conduit and the return conduit, according to the respective function. The part section 11′ which runs in an inclined manner preferably opens into the annular groove 33 which is present for increasing the volume. The annular groove 33 has a rounded cross section and preferably the part section 11′ of the return conduit 11 opens into this annular groove 33. This arrangement is particularly advantageous because the return flow of the hydraulic oil has so much energy that returning hydraulic oil may destroy the sleeve. In order to avoid this destruction, three measures have been realized. As a first measure, the part section 11′ of the return conduit 11 is attached running in an inclined manner so that the return flow does not impinge the sleeve perpendicularly. As a second measure, on one side the annular groove 33 increases the volume and the part section 11′ opens into the annular groove 33 so that a distance from the exit opening of the return conduit 11 to the sleeve is enlarged. And finally, the cross section of the part section 11′ is selected lager than the cross section of the actual return conduit 11. Thus the part section 11′ simultaneously forms the expansion space. The bores 45 and 46 which are additionally present in the piston cylinder unit 4 run perpendicular to the longitudinal axis and open in the forward line 10 or into the suction conduit 10′. The bores 45 and 46 may serve for attaching suitable sensors by which the present oil pressure values may be determined during the pressure build up and pressure reduction. Various information may be deduced from these measurements which do not need to be discussed in detail here. For example, the permeability of the oil filter 43 may be monitored with these readings so that one may recognize when this oil filter needs to be replaced.

1. An electrically operated pressing tool (1) with a hydraulic pump (3) acting on a hydraulic piston cylinder unit (4) actively connected to a roller holder with rollers that roll on the clamping jaws (5) of a clamping pincer (2) and move the clamping jaws (5) relative to one another, wherein the pressing tool (1) has an elastic hydraulic oil accommodation container (6) and an actuation valve (9) for opening a passage from a forward conduit (10) into a return conduit (11) between the hydraulic oil accommodation container (6) and a cylinder space (12) of the piston cylinder unit, wherein the hydraulic oil accommodation container (6) is formed by an elastic sleeve (36) which sealingly encompasses at least a portion of a cylinder housing (13) of the piston cylinder unit (4) and the pressing tool (1) comprises the actuation valve (9) in the piston cylinder unit (4) completely covered by an elastic sleeve (36) and an actuation of the valve being effected by a pressure on the elastic sleeve (36).

2. A pressing tool according to claim 1, wherein the pressing tool apparatus (1) comprises a housing (0) in which a portion of the piston cylinder unit (4) and the pump (3) and the electrical drive (14) are accommodated and which completely covers the elastic sleeve (36), wherein in the housing (0) an actuation button (40) is mounted which on actuation presses onto the sleeve (36) above the actuation valve (9).

3. A pressing tool according to claim 2, wherein the actuation valve (9) is actively connected to an actuation plunger which from spring pressure bears on an inner side of the elastic sleeve (36).

4. A pressing tool according to claim 2, wherein an oil filter (43) is arranged in the region of near the actuation valve which crosses a forward conduit and the actuation plunger passes through an oil filter.

5. A pressing tool according to claim 1, wherein a part of the return conduit is simultaneously a part section of a suction conduit, the and a part section of the suction conduit serving as a return conduit runs inclined to a longitudinal axis of the cylinder housing.

6. A pressing tool according to claim 1, wherein an annular trough for increasing a volume is inwardly formed near the cylinder housing which is covered by the elastic sleeve (36).

7. A pressing tool according to and claim 6, wherein the return conduit running in an inclined manner runs into the annular trough.

8. A pressing tool according to claim 1, wherein the cylinder housing comprises two annular grooves at a distance to one another which is a length of the elastic sleeve (36), and that the elastic sleeve (36) has annular beads sealingly mounted in the annular grooves.

9. A pressing tool according to claim 8, wherein the annular beads are secured in the annular grooves by cable binders.

10. A pressing tool according to claim 5, wherein the return conduit running in an inclined manner runs into the annular trough.
